(19) United States
(12) Patent Application Publication
(10) Pub. No.: US 2024/0160401 A1
(43) Pub. Date: May 16, 2024

(54) Off-LAN Experience for Portables

(71) Applicant: Sonos, Inc., Santa Barbara, CA (US)

(72) Inventors: Bruce Weathered von Kugelgen, Oakland, CA (US); Marisa McKently, Mountain View, CA (US); Michael Nuzzolo, South Boston, MA (US); Michelle Diane Sintov, San Francisco, CA (US); Damjan Stulic, San Francisco, CA (US); Ryan Edward Kitson, Bay City, OR (US)

(21) Appl. No.: 18/549,543

(22) PCT Filed: Mar. 8, 2022
(86) PCT No.: PCT/US2022/019296

§ 371 Date: Sep. 7, 2023

Related U.S. Application Data
(60) Provisional application No. 63/158,079, filed on Mar. 8, 2021.

(51) Int. Cl. G06F 3/16

(52) U.S. Cl. CPC G06F 3/165; G06F 3/162

(57) ABSTRACT

An example computing device is configured to use a first communication protocol to connect to a local network. After connecting to the local network, the computing device uses the first communication protocol to receive first information identifying a first playback device connected to the local network. The computing device also uses a second communication protocol different from the first communication protocol to connect to a second playback device that is not connected to the local network. Further, the computing device uses a third communication protocol different from the first and second communication protocols to receive second information identifying the second playback device. The computing device displays (i) a first representation of the first playback device based on the first information identifying the first playback device and (ii) a second representation of the second playback device based on the second information identifying the second playback device.

### CROSS-REFERENCE TO RELATED APPLICATIONS

This application claims the benefit of priority to U.S. Provisional Patent App. No. 63/158,079, filed Mar. 8, 2021, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example corresponding media playback system zones.

FIG. 2 is a schematic diagram of example media playback system areas.

FIG. 3 is an isometric diagram of an example playback device housing.

FIG. 4 is a diagram of an example headset assembly for the playback device of FIG. 3.

FIG. 5A is a schematic diagram of an example user interface of the example control device of FIG. 1H.

FIG. 5B is a schematic diagram of another example user interface of the example control device of FIG. 1H.

FIG. 6 is a schematic diagram of an example media playback system.

FIG. 7A is a schematic diagram of another example user interface of the example control device of FIG. 1H.

FIG. 7B is a schematic diagram of another example user interface of the example control device of FIG. 1H.

FIG. 7C is a schematic diagram of another example user interface of the example control device of FIG. 1H.

FIG. 8 is a flowchart showing example operations for displaying representations of on-LAN and off-LAN playback devices in a graphical interface of a control device.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to techniques for improving a user's experience by providing a user interface on a control device that displays representations of both on-LAN and off-LAN playback devices in a media playback system (MPS). As used herein, the term “on-LAN playback devices” may refer to playback devices in a state where such devices are connected to the same local network as the control device and that communicate with the control device using a communication protocol supported by the local network. Conversely, the term “off-LAN playback devices” may refer to playback devices in a state where such devices are not connected to the same local network as the control device and/or that communicate with the control device using a communication protocol that is not supported by the local network. Examples of playback devices made by SONOS, Inc. that may operate as on-LAN playback devices that communicate over WiFi and/or Ethernet and/or as off-LAN playback devices that communicate over BLUETOOTH include SONOS MOVE and SONOS ROAM.

As described in further detail below, the control device is configured to receive user input related to the MPS and, in response, cause one or more devices in the MPS to perform an action or operation corresponding to the user input. In order to provide such functionality, the control device can display representations of the various playback devices in the MPS as well as their operational statuses, such as whether a device is playing back media content and what the media content is.

In practice, the control device receives, via the local network, information identifying the various playback devices connected to the local network and their operational statuses. The control device then uses this information to populate the displayed representations of the playback devices. However, when the MPS includes off-LAN playback devices that are not connected to the local network, the control device does not receive identifying information for these devices via the local network. As such, the control device can fail to display representations of the off-LAN playback devices, resulting in a poor user experience. For example, a user who opens a controller application on their smartphone while only connected to a playback device over a BLUETOOTH connection may only see a static message indicating “no playback devices found.” As a result, the control experience for the user is limited to those features that are provided in the underlying operating system of the smartphone for standard BLUETOOTH classic connections. In another example, a user may open the controller application on their smartphone while connected to a first playback device over WiFi and a second playback device over a BLUETOOTH connection. In such an instance, the user may only see the first playback device in the controller application despite also having an ongoing connection to the second playback device. Further, there is no single interface in which a user can see status information or otherwise control both playback devices. The status of the first playback device is visible in a controller application while the status of the second playback device is visible via user interface screens integrated into the underlying operating system of the smartphone.

In order to help address these issues, the control device can be configured to use a different communication protocol to receive information identifying the off-LAN playback devices and their operational statuses. As a result, a user may be able to see status information of (or otherwise control) an off-LAN playback device using a controller application on their smartphone instead of being limited to control using the limited features built into the underlying operating system of the smartphone. Further, a user may be able to see status information for (or otherwise control) off-LAN and on-LAN playback devices in a single interface (e.g., the controller application on their smartphone). To illustrate, consider an example in which the control device uses WiFi and/or Ethernet to communicate with on-LAN playback devices, and the control device uses BLUETOOTH to stream media content to off-LAN playback devices. In such an example, the control device can use a communication protocol such as BLUETOOTH low energy (BLE), which is different from WiFi, Ethernet, and BLUETOOTH classic, to obtain identifying information from the off-LAN playback devices. The control device can then produce representations of both the on-LAN playback devices (e.g., in a single interface) using the information received over the local network, as well as the off-LAN playback devices using the information received over BLE.

In some embodiments, for example, a computing device is provided including at least one processor, at least one communication interface, a display configured to present a graphical interface, a non-transitory computer-readable medium, and program instructions stored on the non-transitory computer-readable medium that are executable by the at least one processor such that the computing device is configured to (i) use a first communication protocol to connect, via the at least one communication interface, to a local area network, (ii) use the first communication protocol to receive, via the at least one communication interface, first information identifying a first playback device connected to the local area network, (iii) use a second communication protocol different from the first communication protocol to connect, via the at least one communication interface, to a second playback device that is not connected to the local area network, (iv) use a third communication protocol different from the first and second communication protocols to receive, via the at least one communication interface, second information identifying the second playback device, and (v) display, via the graphical interface, a first representation of the first playback device and a second representation of the second playback device, wherein the first representation is based on the first information identifying the first playback device and the second representation is based on the second information identifying the second playback device.

In another aspect, a non-transitory computer-readable medium is provided. The non-transitory computer-readable medium is provisioned with program instructions that, when executed by at least one processor, cause a computing device to (i) use a first communication protocol to connect, via at least one communication interface of the computing device, to a local area network, (ii) use the first communication protocol to receive, via the at least one communication interface, first information identifying a first playback device connected to the local area network, (iii) use a second communication protocol different from the first communication protocol to connect, via the at least one communication interface, to a second playback device that is not connected to the local area network, (iv) use a third communication protocol different from the first and second communication protocols to receive, via the at least one communication interface, second information identifying the second playback device, and (v) display, via a graphical interface of the computing device, a first representation of the first playback device and a second representation of the second playback device, wherein the first representation is based on the first information identifying the first playback device and the second representation is based on the second information identifying the second playback device.

In yet another aspect, a method carried out by a computing device includes, (i) using a first communication protocol to connect, via at least one communication interface of the computing device, to a local area network, (ii) using the first communication protocol to receive, via the at least one communication interface, first information identifying a first playback device connected to the local area network, (iii) using a second communication protocol different from the first communication protocol to connect, via the at least one communication interface, to a second playback device that is not connected to the local area network, (iv) using a third communication protocol different from the first and second communication protocols to receive, via the at least one communication interface, second information identifying the second playback device, and (v) displaying, via a graphical interface of the computing device, a first representation of the first playback device and a second representation of the second playback device, wherein the first representation is based on the first information identifying the first playback device and the second representation is based on the second information identifying the second playback device.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

a. Suitable Media Playback System

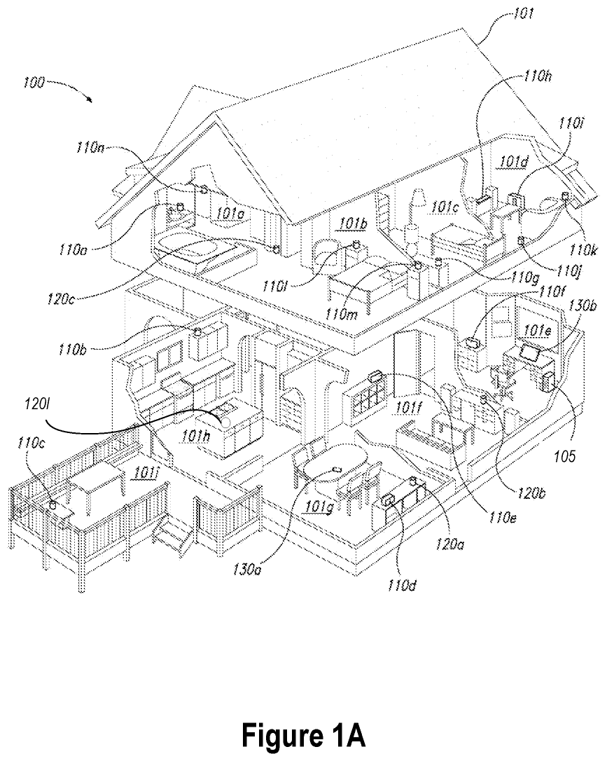

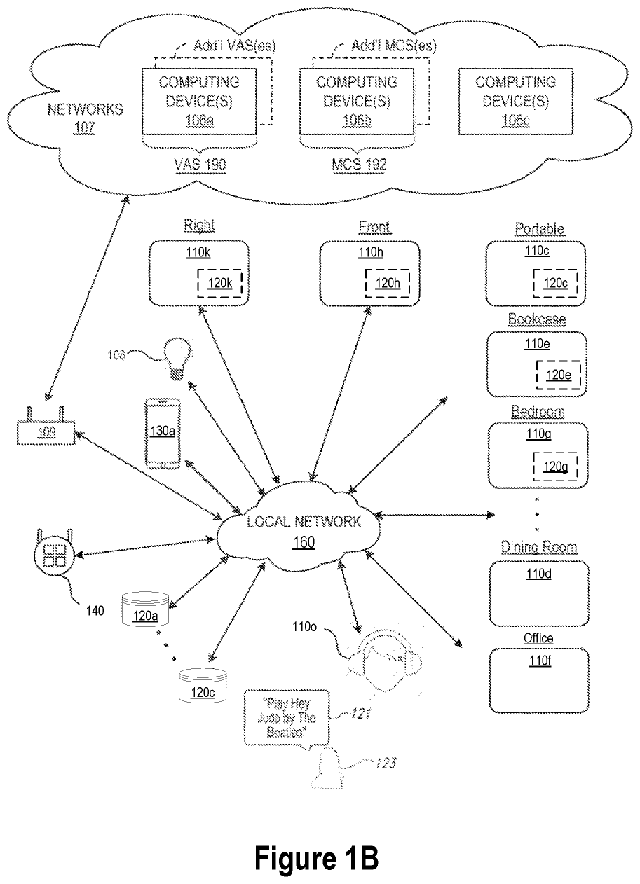

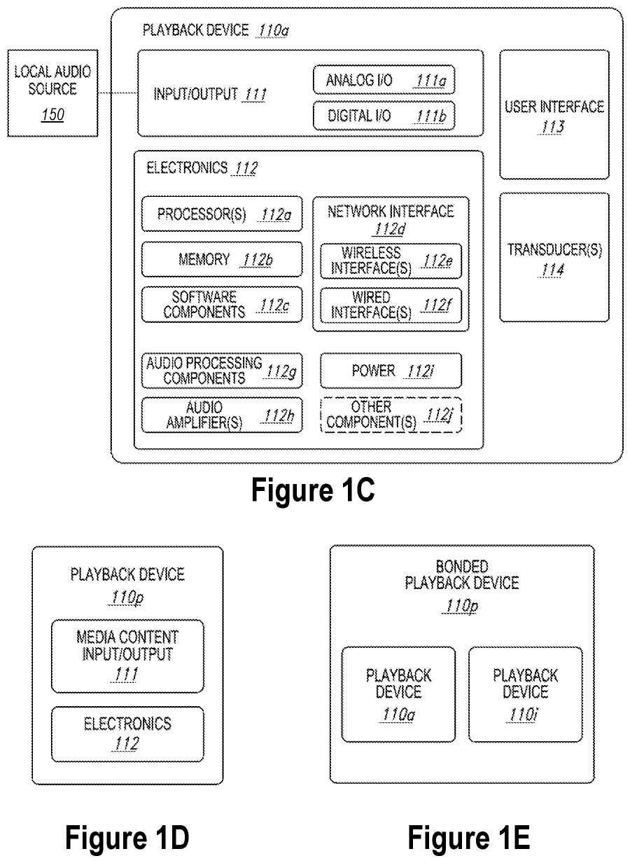

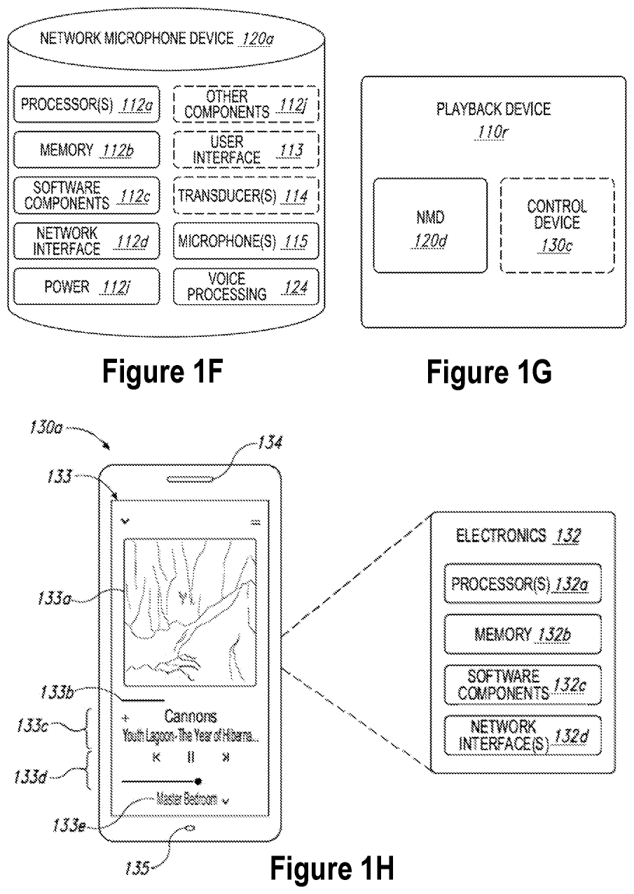

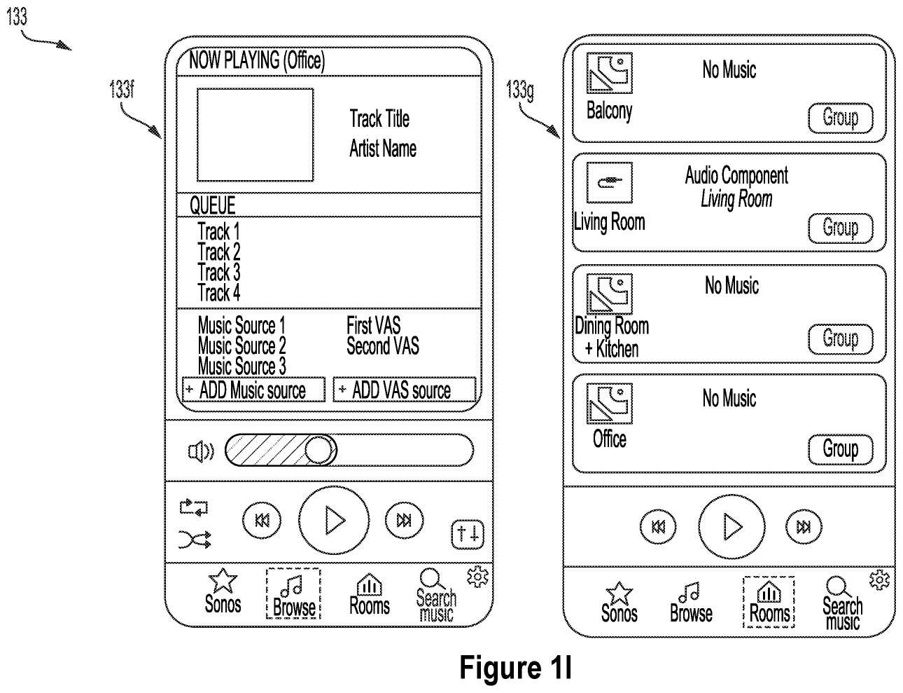

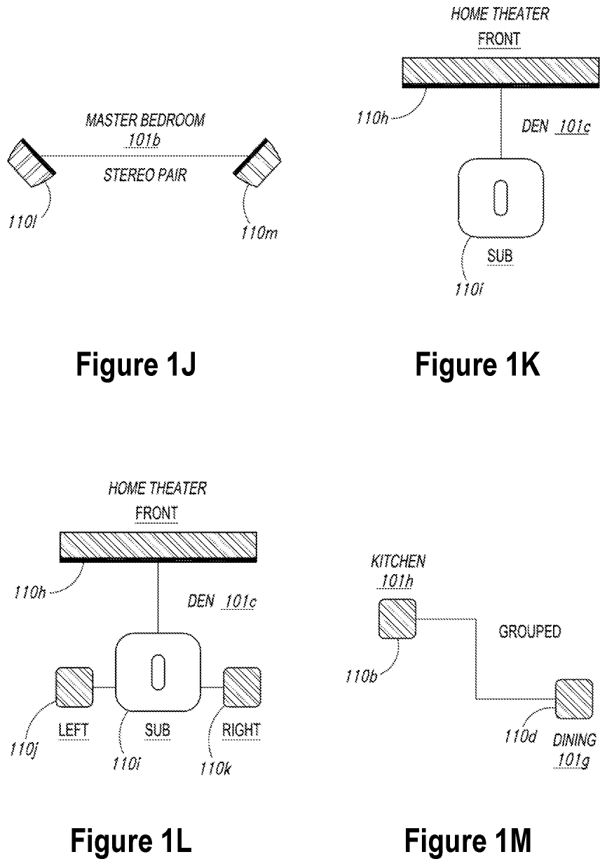

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 100a) in synchrony with a second playback device (e.g., the playback device 100b). Interactions between the playback devices 110, NMDs 120, and/or control devices 130 of the MPS 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108 (FIG. 1B), a smart thermostat 140, and a local computing device 105 (FIG. 1A). In embodiments described below, one or more of the various playback devices 110 may be configured as portable playback devices, while others may be configured as stationary playback devices. For example, the headphones 110o (FIG. 1B) are a portable playback device, while the playback device 110e on the bookcase may be a stationary device. As another example, the playback device 110c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WiFi network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY, PANDORA, AMAZON MUSIC, GOOGLE PLAY, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WiFi network). In some embodiments, the MPS 100 is implemented without the local network 160, and the various devices comprising the MPS 100 can communicate with each other, for example, via one or more direct connections, PANs, telecommunication networks (e,g., an LTE network or a 5G network, etc.), and/or other suitable communication links.

In some embodiments, audio content sources may be regularly added or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to receive voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 120l may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 120l may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio may be named “Portable” because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Patent Publication No. 2017-0242653 published Aug. 24, 2017, and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Patent Publication No. 2017-0242653.

In certain implementations, an NMD may be assigned to, or otherwise associated with, a designated or default playback device that may not include an NMD. For example, the Island NMD 120l in the Kitchen 101h (FIG. 1A) may be assigned to the Dining Room playback device 110d, which is in relatively close proximity to the Island NMD 120l. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Publication No. 2017-0242653.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, BLUETOOTH, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operable coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WiFi, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more of lights (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

In some embodiments, one or more of the playback devices 110 may take the form of a wired and/or wireless headphone (e.g., an over-ear headset, an on-ear headset, or an in-ear headset). For instance, FIG. 4 shows an example headset assembly 400 (“headset 400”) for such an implementation of one of the playback devices 110. As shown, the headset 400 includes a headband 402 that couples a first earcup 404a to a second earcup 404b. Each of the earcups 404a and 0244b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to ear cups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

As described in greater detail below, the electronic components of a playback device may include one or more network interface components (not shown in FIG. 4) to facilitate wireless communication over one more communication links. For instance, a playback device may communicate over a first communication link 401a (e.g., a BLUETOOTH link) with one of the control devices 130 and/or over a second communication link 401b (e.g., a WiFi or cellular link) with one or more other computing devices 410 (e.g., a network router and/or a remote server). As another possibility, a playback device may communicate over multiple communication links, such as the first communication link 401a with the control device 130a and a third communication link 401c (e.g., a WiFi or cellular link) between the control device 130a and the one or more other computing devices 410. Thus, the control device 130a may function as an intermediary between the playback device and the one or more other computing devices 410, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMD)s

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The microphones 115 are configured to detect sound (i.e., acoustic waves) in the environment of the playback device 110r, which is then provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Patent Publication No. 2017-0242653.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Controller Devices

FIG. 1H is a partially schematic diagram of one of the control device 130a (FIGS. 1A and 1B). As used herein, the term “control device” can be used interchangeably with “controller,” “control device,” or “control system.” Among other features, the control device 130a is configured to receive user input related to the MPS 100 and, in response, cause one or more devices in the MPS 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the MPS 100. The memory 132b can comprise data storage that can be loaded with one or more of the software components executable by the processor 302 to perform those functions. The software components 132c can comprise applications and/or other executable software configured to facilitate control of the MPS 100. The memory 112b can be configured to store, for example, the software components 132c, media playback system controller application software, and/or other data associated with the MPS 100 and the user.

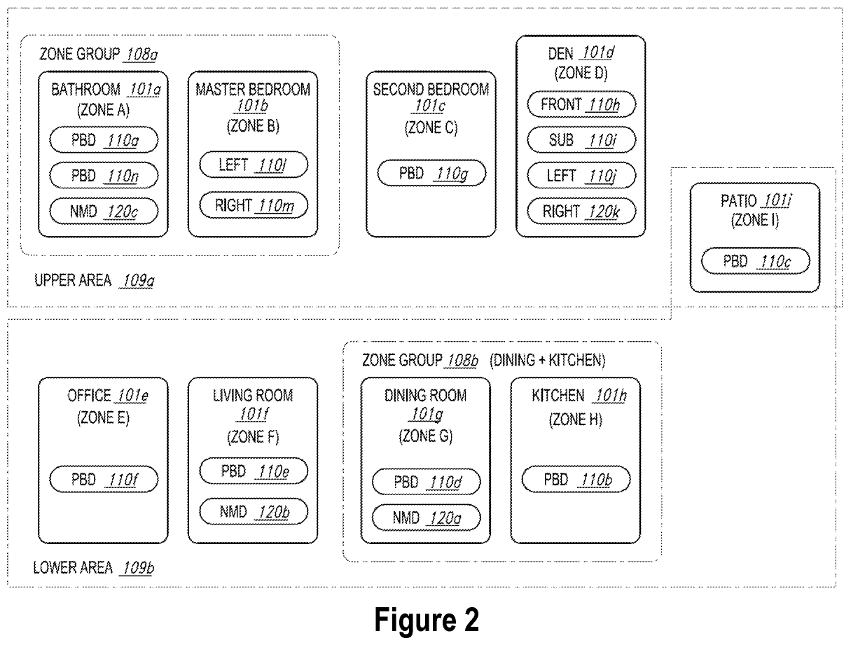

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others. Additional description of zones and groups can be found below with respect to FIGS. 1J through 2.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system. FIG. 1I shows two additional user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1J through 2 show example configurations of playback devices in zones and zone groups. Referring first to FIG. 2, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback zones 110g and 110h can be merged to form a merged group or a zone group 108b. The merged playback zones 110g and 110h may not be specifically assigned different playback responsibilities. That is, the merged playback zones 110h and 110i may, aside from playing audio content in synchrony, each play audio content as they would if they were not merged.

Each zone in the MPS 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1L shows the Front and SUB devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 2).

Playback devices that are merged may not have assigned playback responsibilities and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 2, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 2. In some embodiments, a zone group may be given a unique name selected by a user.

Certain data may be stored in a memory of a playback device (e.g., the memory 112c of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1M). Identifiers associated with the Kitchen may indicate the same or similar information by virtue of the Kitchen being part of the Dining+Kitchen zone group 108b. Other example zone variables and identifiers are described below.

In yet another example, the MPS 100 may include variables or identifiers representing other associations of zones and zone groups, such as identifiers associated with Areas, as shown in FIG. 2. An area may involve a cluster of zone groups and/or zones not within a zone group. For instance, FIG. 2 shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

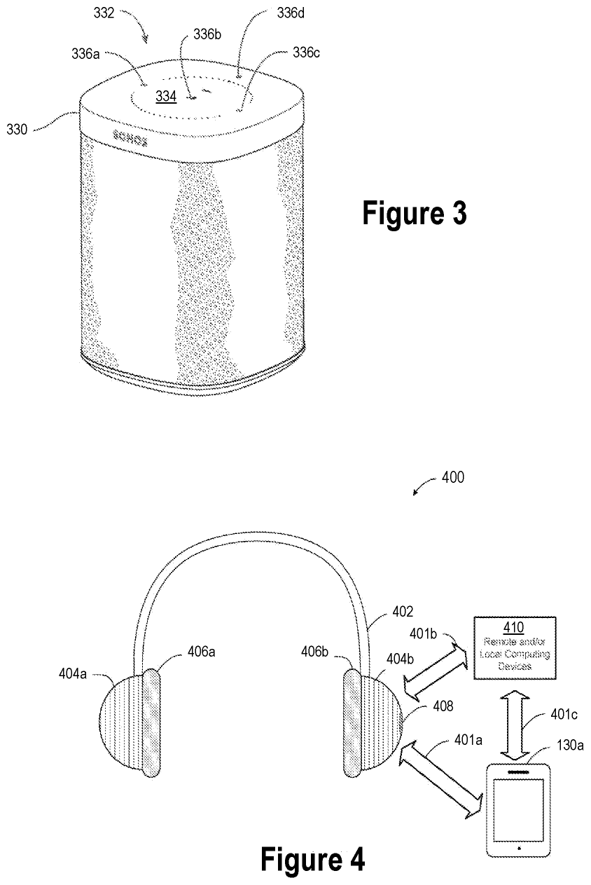

FIG. 3 shows an example housing 330 of the playback device 110 that includes a user interface in the form of a control area 332 at a top portion 334 of the housing 330. The control area 332 includes buttons 336-c for controlling audio playback, volume level, and other functions. The control area 332 also includes a button 236d for toggling the microphones 222 to either an on state or an off state. The control area 332 is at least partially surrounded by apertures formed in the top portion 334 of the housing 330 through which the microphones 222 (not visible in FIG. 3) receive the sound in the environment of the playback device 110. The microphones 222 may be arranged in various positions along and/or within the top portion 334 or other areas of the housing 330 so as to detect sound from one or more directions relative to the playback device 110.

In some embodiments, the playback device 110 may take the form of a wired and/or wireless headphone (e.g., an over-ear headset, an on-ear headset, or an in-ear headset). For instance, FIG. 4 shows an example headset assembly 400 (“headset 400”) for such an implementation of the playback device 110. As shown, the headset 400 includes a headband 402 that couples a first earcup 404a to a second earcup 404b. Each of the earcups 404a and 404b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to ear cups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

### III. Example Techniques Involving Off-LAN Playback Devices

As described above in connection with FIGS. 1H and 1I, the control device 130a can display, via the user interface 133, representations of various playback devices and/or groupings of playback devices in the MPS 100. In order to populate the user interface 133 with the representations of the playback devices in the MPS 100, the control device 130a is configured to receive metadata from the playback devices of the MPS 100 when connected to a shared network with the playback devices. For instance, as described above, the control device 130a and the playback devices of the MPS 100 are coupled to one another via the local network 160. As further described above, the local network 160 can be a LAN, and the control device 130a can communicate with the playback devices connected to the local network 160 using an 802.11 based protocol. The control device 130a receives the metadata from the playback devices over the local network 160 and uses the metadata to display the representations of the playback devices via the user interface 133. The metadata can include information identifying the playback devices themselves as well as information identifying media content being played back by the playback devices. As such, the control device 130a can include in the displayed representations information identifying the playback devices and any media content being played back by the playback devices, as shown in FIGS. 1H and 1I.

In order to improve an end-user experience, it can also be desirable to display representations of playback devices that are not connected to the local network 160, but that are still capable of being controlled by, or otherwise interfacing with, the control device 130a. For instance, as described above in connection with FIG. 1B, a household may include one or more playback devices that are configured to communicate with the control device 130a using a communication protocol that is incompatible with communication protocols supported by the local network 160. As an example, playback devices connected to the local network 160 can be configured to communicate with the control device 130a using the 802.11 based protocol, while other playback devices that are not connected to the local network 160 can be configured to communicate with the control device 130a using the BLUETOOTH and/or BLE protocols. Unless otherwise denoted, the use of the term “BLUETOOTH” herein refers to BLUETOOTH classic, also known as BLUETOOTH Basic Rate/Enhanced Data Rate (BR/EDR), and the term “BLE” refers to BLUETOOTH low energy (BLE). And while the examples described herein involve these particular communication protocols, examples using other communication protocols are contemplated herein as well. Further, throughout this disclosure, playback devices that are connected to a local network in common with the control device 130a (e.g., local network 160) are referred to as “on-LAN playback devices,” and playback devices that are not connected to a local network in common with the control device 130a are referred to as “off-LAN playback devices.”

In order to control an off-LAN playback device, the control device 130a can pair with the off-LAN playback device to establish a BLUETOOTH connection. Once paired, the control device 130a can stream media content over the BLUETOOTH connection from the control device 130a to the off-LAN playback device for playback. The control device 130a can be configured to display a representation of the off-LAN playback device via the user interface 133 when the control device 130 is paired with the off-LAN playback device via a BLUETOOTH connection.

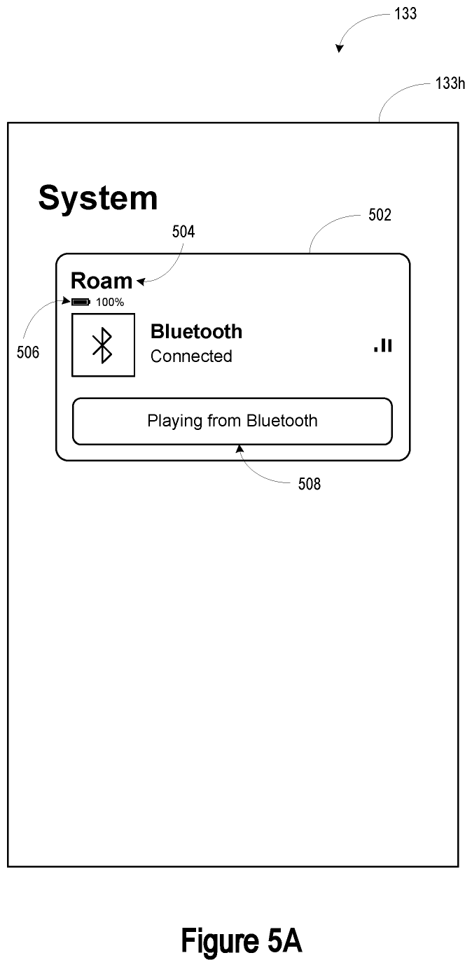

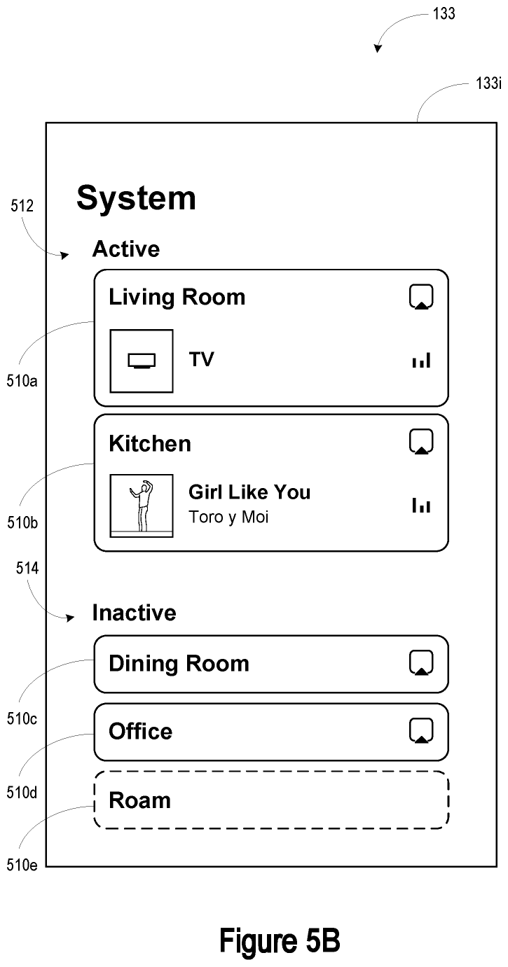

FIG. 5A shows an example display 133h of the user interface 133 in which the control device 130a displays a representation 502 of an off-LAN playback device paired with the control device 130a via a BLUETOOTH connection. In order to facilitate displaying the representation 502, the control device 130a can receive metadata identifying the off-LAN playback device. For example, while the control device 130a is paired with the off-LAN playback device via a BLUETOOTH connection, the off-LAN playback device can send identifying information to the control device 130a over the BLUETOOTH connection. The identifying information can include various information identifying the off-LAN playback device, such as a device name, serial number, model name or number, as well as status information, such as battery power level or information identifying media being played back by the off-LAN device, such as a song title, artist, album name, album art, media genre, or the like. In some examples, instead of directly sending the identifying information to the control device 130a, the off-LAN playback device can indirectly send some or all of the information. As an example, the off-LAN playback device can send a URL to the control device 130a, and the control device 130a can retrieve the identifying information by accessing the URL. Additionally or alternatively, some of this information can be determined by the control device 130a regardless of whether the off-LAN device provides the information to the control device 130a. For instance, the control device 130a can determine characteristics of the media being played back by the off-LAN playback device based on the media that the control device 130a is streaming to the off-LAN playback device for playback.

The control device 130a can use some or all of the identifying information to populate the representation 502 of the off-LAN playback device. For instance, in the illustrated example, the control device 530a populates the representation 502 with a device name 504, a battery power level 506, and playback status information 508 of the off-LAN playback device. In other examples, the control device 130a can populate the representation 502 with more or less detailed information. Additionally, in some examples, the control device 130a can display more detailed information in response to receiving a user interaction with the representation 502, such as a touch input on the representation 502.

Notably, in the example depicted in FIG. 5A, the control device 130a does not display representations of the on-LAN playback devices concurrently with the off-LAN playback device representation 502. In this example, the control device 130a can transition to displaying representations of the on-LAN playback devices when the control device 130a stops streaming media to the off-LAN playback device and/or terminates the BLUETOOTH connection with the off-LAN playback device.

FIG. 5B shows an example display 133i of the user interface 133 in which the control device 130a displays representations 510 (identified individually as representations 510a, 510b, 510c, and 510d) of on-LAN playback devices in communication with the control device 130a. The control device 130a can be configured to cause the user interface 133 to present this display 133i when the control device 130a is not streaming media to an off-LAN device and/or when the control device 130a disconnects from an off-LAN device.

As described above, the control device 130a can populate the representations 510 with information received from the on-LAN playback devices or device groups identifying the devices or groups and their operating statuses. The control device 130a receives the identifying information from one or more of the on-LAN devices via the local network 160. As such, in the present example, the control device 130a receives the identifying information for the on-LAN devices using an 802.11 based communication protocol.

In the example depicted in FIG. 5B, the control device 130a receives information identifying the names of the on-LAN playback devices and/or playback zones as “Living Room,” “Kitchen,” “Dining Room,” and “Office.” Accordingly, the control device 130a causes the display 133i to include a representation 510a corresponding to the Living Room device or zone, a representation 510b corresponding to the Kitchen device or zone, a representation 510c corresponding to the Dining Room device or zone, and a representation 510d corresponding to the Office device or zone. The control device 130a also receives information identifying media content being played back by the Living Room and Kitchen devices or zones. Namely, the control device 130a receives information identifying that the TV is playing at the Living Room and the song “Girl Like You” by Toro y Moi is playing at the Kitchen, and the control device 130a populates the representations 510a and 510b accordingly. Further, the control device 130a can be configured to display the representations 510 in a manner that indicates whether each corresponding playback device is actively playing back media content. In some examples, the control device 130a can arrange the representations 510 that correspond to active playback devices in a prominent position in the display 133i while arranging the representations 510 of the inactive playback devices in a less prominent position in the display 133i. For instance, because the received information identifies that the Living Room and Kitchen devices or zones are currently playing back media content, the control device 130a positions their representations 510a and 510b in an active region 512 at the top of the display 133i. Conversely, because the received information does not identify that the Dining Room and Office devices or zones are currently playing back media content, the control device 130a positions their representations 510c and 510d in an inactive region 514 below the active region 512 of the display 133i.

Additionally, the control device 130a can provide various transport controls for controlling media playback via the user interface 133. In some examples, the control device 130a displays respective transport controls in the respective representations 510 of the playback devices or zones in response to receiving a user interaction with one of the representations 510. For instance, in response to receiving a selection of one of the representations 510, the control device 130a can expand the selected representation to display transport controls for controlling the playback device or zone associated with the selected representation. An example of an expanded representation that includes transport controls is described above in connection with FIG. 1H. And when the control device 130a receives an input via the displayed transport controls, the control device 130a can send a corresponding transport control command to the appropriate playback device via the local network 160 using the 802.11 based protocol.

As further shown in FIG. 5B, the control device 130a can optionally display a representation 510e of the off-LAN device (shown in dashed lines) to which the control device 130a previously streamed media content. To facilitate this, the control device 130a can store the information identifying the off-LAN device that the control device 130a received via the BLUETOOTH connection and used to populate the representation 502 of the off-LAN device depicted in FIG. 5A. When the BLUETOOTH connection between the control device 130a and the off-LAN device is terminated, the control device 130a can transition to displaying the display 133i shown in FIG. 5B, and the control device 130a can use the stored information identifying the off-LAN device to populate the representation 510e of the off-LAN device. Because the control device 130a is no longer streaming media content to the off-LAN device, the control device 130a can position the representation 510e of the off-LAN device in the inactive region 514 of the display 133i.

While the examples depicted in FIGS. 5A and 5B are useful for displaying representations of both on-LAN and off-LAN devices, these examples have some notable shortcomings. For instance, in the example shown in FIG. 5A, when the control device 130a is streaming media to an off-LAN device using a BLUETOOTH connection, the control device 130a only displays a representation 502 of the off-LAN device and does not display representations of any on-LAN devices. Additionally, the representation 502 of the off-LAN device does not include any transport controls for controlling media playback at the off-LAN device. Still further, when the control device 130a disconnects from the off-LAN device, the control device 130a can display the representation 510e of the off-LAN device in the inactive region 514 of the display 133i, but it is possible for the off-LAN device to be actively playing back media content. For instance, a different control device could establish a BLUETOOTH connection with the off-LAN device for streaming media content, and the control device 130a would be unaware. As such, the control device 130a could mistakenly characterize the off-LAN device as inactive. Each of these shortcomings can lead to a poor end-user experience.

To address these shortcomings of the previous examples, the control device 130a can be configured to communicate with off-LAN devices using a third communication protocol that is separate from the protocols supported by the local area network 160 and the protocol used to stream media to the off-LAN device. Namely, in the examples described herein, the control device 130a can be configured to communicate with off-LAN devices using the BLE protocol, while still using the BLUETOOTH protocol for streaming media content to off-LAN devices and using the 802.11 based protocol for communicating with on-LAN devices. Again, however, these specific protocols are for illustrative purposes only, and other communication protocols can be used to the same effect.

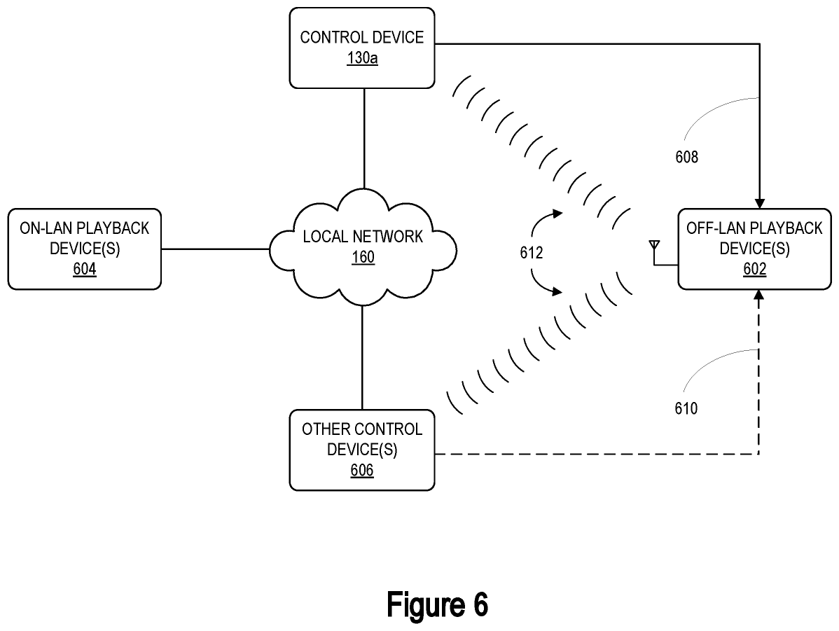

FIG. 6 shows an example media playback system (MPS) 600 for performing the techniques described herein. The MPS 600 can include some or all of the devices in the MPS 100 described above in connection with FIG. 1. As shown, the MPS 600 includes the control device 130a, one or more off-LAN playback devices 602, one or more on-LAN playback devices 604, and one or more other control devices 606. The other control devices 606 can take the same form as any of the control devices 130 described above. The on-LAN playback devices 604 can take the same form as any of the playback devices 110 described above. The off-LAN playback devices 602 can take the same form as any of the playback devices 110 described above so long as they have BLUETOOTH and BLE capabilities. Commercial examples of an off-LAN playback device 602 include the SONOS MOVE or the SONOS ROAM playback devices.

As shown in FIG. 6, the control device 130a, the on-LAN playback devices 604, and the other control devices 606 are connected to the local network 160. As such, the control device 130a and/or the other control devices 606 can control media playback by the on-LAN devices by using the 802.11 based protocol to communicate with the on-LAN devices via the local network 160 in any of the manners described herein.

The off-LAN playback devices 602 are not connected to the local network 160. Alternatively, the off-LAN playback devices 602 can be connected to the local network 160, but the off-LAN playback devices 602 and/or the control device 130a can be operating in a mode (e.g., a BLUETOOTH streaming mode) that restricts or prevents the control device 130a from using the local network 160 to control media playback of the off-LAN playback devices 602. As such, the control device 130a and/or the other control devices 606 can establish BLUETOOTH connections with the off-LAN playback devices 602 for streaming media content to the off-LAN playback devices 602. In the example shown in FIG. 6, the control device 130a has established a BLUETOOTH connection 608 with the off-LAN playback device 602 and is streaming media content to the off-LAN playback device 602 via the BLUETOOTH connection 608. However, as further shown in FIG. 6, one of the other control devices 606 can alternatively establish a BLUETOOTH connection 610 with the off-LAN playback device 602 and stream media content to the off-LAN playback device 602 via the BLUETOOTH connection 610.

Additionally, the off-LAN device 602 can be configured to use the BLE protocol to transmit identifying information that includes some or all of the identifying information of the off-LAN device 602 described above. For instance, the identifying information can include information identifying the off-LAN device 602 itself, such as a device name, serial number, model name, or model number. The identifying information can also include information identifying an operational status of the off-LAN device 602, such as a battery level of the device, an indication of whether the device 602 is playing back media content, a timestamp of the playback position in the media content, or a title, artist, album, album art, or genre of the media content. However, these examples are merely illustrative, and the identifying information can include any other apparent information for identifying the off-LAN device 602 and/or its operational status.

The off-LAN playback device 602 can transmit the identifying information in various ways. In some examples, and as shown in FIG. 6, the off-LAN playback device 602 can output a BLE beacon 612 that includes the information. The off-LAN playback device 602 can transmit the beacon 612 periodically or in response to a trigger event, such as in response to a change in operational status. For example, the off-LAN playback device 602 can transmit the beacon 612 when the off-LAN playback device 602 is powered on, when media playback is initiated at the off-LAN playback device 602, or when media playback is stopped at the off-LAN playback device 602. In this configuration, the off-LAN playback device 602 can act as a broadcaster in the BLE framework, and the control device 130a can act as an observer. As such, the off-LAN playback device 602 can broadcast the identifying information in the beacon 612, and the control device 130a can receive the identifying information without establishing a specific BLE connection between the devices. This allows the off-LAN playback device 602 to broadcast the identifying information to multiple control devices simultaneously. For instance, as shown, the off-LAN playback device 602 broadcasts the beacon 612 to both the control device 130a and the other control devices 606.

In other examples, the off-LAN playback device 602 can output an advertising packet for establishing a BLE connection. The control device 130a can receive the advertising packet and establish a connection with the off-LAN playback device 602. The off-LAN playback device 602 can then send the identifying information to the control device 130a via the established BLE connection. In such a configuration, it can be advantageous to terminate the BLE connection once the identifying information is transferred so that the off-LAN playback device 602 is available to establish BLE connections with, and providing the identifying information to, the other control devices 606.

In some examples, the control device 130a can be configured to use information previously received from the off-LAN playback device 602 using the BLUETOOTH protocol in order to obtain the identifying information using the BLE protocol. For example, when the control device 130a establishes a BLUETOOTH connection with the off-LAN playback device 602 for streaming media to the off-LAN playback device 602, the control device 130a receives certain information identifying the off-LAN playback device 602. As a specific example, when the control device 130a establishes a BLUETOOTH connection with a SONOS playback device, such as the SONOS ROAM, the SONOS playback device reports its device name and the last four digits of its serial number. As such, the control device 130a can search for a BLE beacon from an off-LAN playback device that has the same last four digits of the serial number and extract the identifying information from that BLE beacon. Other examples are possible as well.

In any case, when the control device 130a receives the identifying information using the BLE protocol, the control device 130a uses the identifying information to display a representation of the off-LAN playback device 602 via the user interface 133 of the control device 130a.

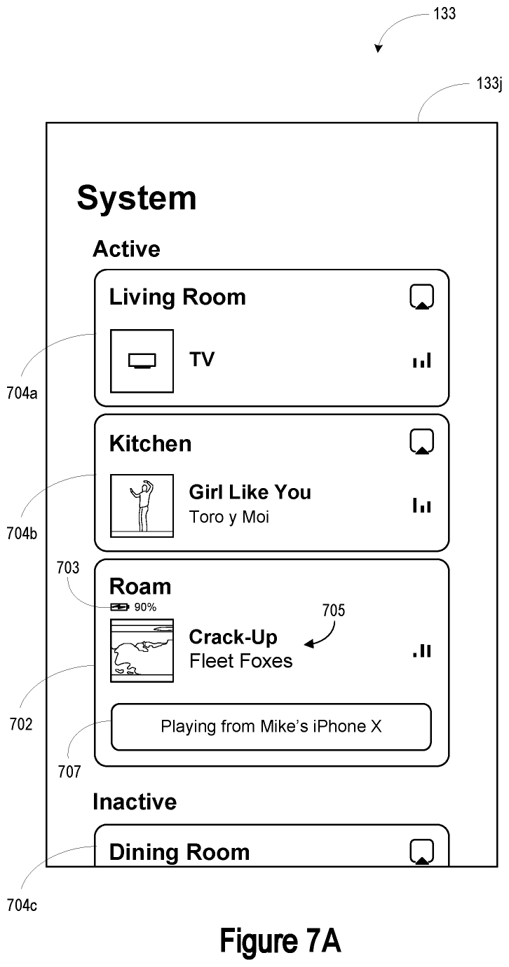

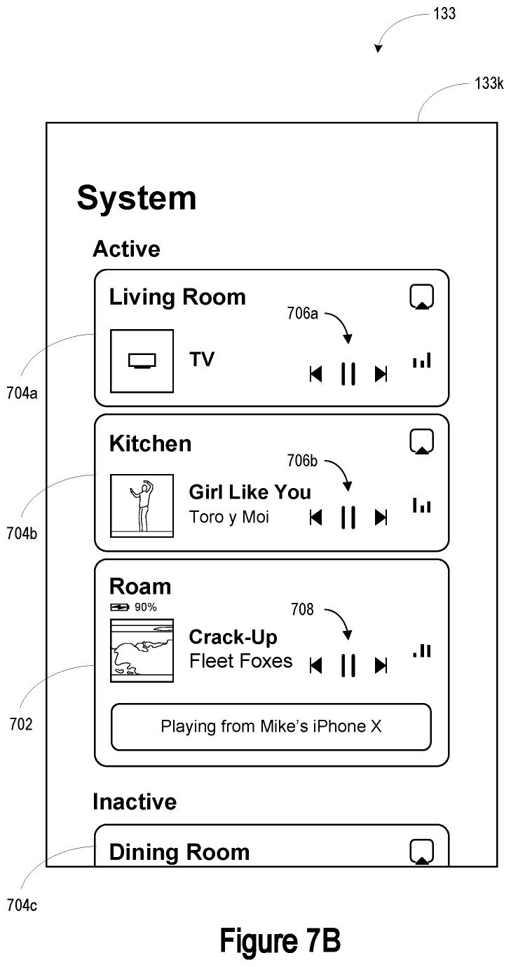

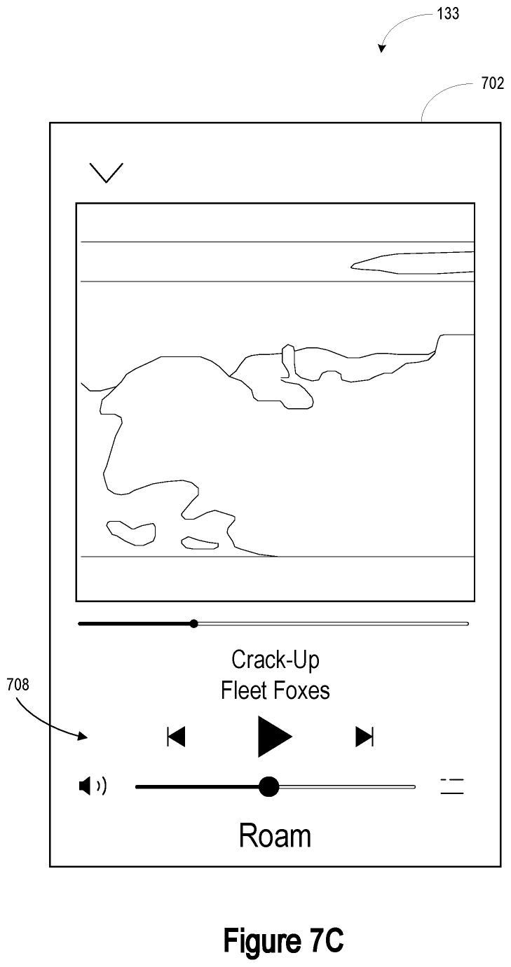

FIG. 7A shows an example display 133j of the user interface 133 in which the control device 130a displays a representation 702 of the off-LAN playback device 602. In this example, the control device 130a displays the representation 702 of the off-LAN playback device 602 concurrently with representations 704 (identified individually as representations 704a, 704b, and 704c) of the on-LAN playback devices 604. And while the display 133j shown in FIG. 7A displays the off-LAN device representation 702 concurrently with the on-LAN device representations 704, the control device 130a can display only the representation 702 of the off-LAN playback device 602 if the control device 130a disconnects from the local network 160 or if there are no on-LAN playback devices 604 connected to the local network 160.

In order to produce the display 133j shown in FIG. 7A, the control device 130a uses the identifying information received from the on-LAN playback devices 604 via the local network 160 using the 802.11 based protocol to populate the representations 704 of the on-LAN playback devices 604, and the control device 130a uses the identifying information received from the off-LAN playback device 602 using the BLE protocol to populate the representation 702 of the off-LAN playback device 602. By using the BLE protocol to obtain the identifying information, the control device 130a can receive identifying information that it may not have been capable of receiving using the BLUETOOTH protocol, such as information identifying media content streamed to the off-LAN playback device 602 from one of the other control devices 606, information identifying the other control device 606 that is streaming the media content to the off-LAN playback device 602, and more detailed information regarding the operational status of the off-LAN playback device 602, such as a charging status (e.g., whether the off-LAN playback device 602 is charging) or power source information (e.g., whether the off-LAN playback device 602 is running on battery power or A/C wall power).

Similar to the example described above in connection with FIG. 5B, the control device 130a can populate the representations 702 and 704 with varying amounts of information identifying the devices themselves and/or operational statuses of the devices. As shown, the control device 130a populates the representation 702 of the off-LAN playback device 602 with more detailed information than that depicted in FIG. 5A. Namely, the control device 130a further displays a charge status indicator 703 indicating that the off-LAN playback device 602 is charging, media playback information 705 identifying a title, artist, and album artwork of the media content being played back by the off-LAN playback device, and media source information 707 identifying the other control device 606 that is streaming the media content to the off-LAN playback device. Additionally, the control device 130a can position the representations within the display 133j based on whether the each representation is associated with a device that is actively playing back media or a device that is inactive, as described above in connection with FIG. 5B.

In some examples, the control device 130a can provide various controls in the representations 702 and 704 for controlling playback of media content by the corresponding playback devices, such as transport controls, volume controls, and/or equalization controls. For example, FIG. 7B shows an example display 133k that includes transport controls. As shown, the control device 130a can display transport controls 706a in representation 704a for controlling playback of media by the Living Room on-LAN playback device; the control device 130a can display transport controls 706b in representation 704b for controlling playback of media by the Kitchen on-LAN playback device; and the control device 130a can display transport controls 708 in representation 702 for controlling playback of media by the off-LAN playback device 602.

FIG. 7C shows another example in which the representation 702 of the off-LAN playback device 602 includes transport and volume controls 708 for controlling playback of media by the off-LAN playback device 602. As shown, the representation 702 is an enlarged representation that includes additional details of the off-LAN playback device 602, similar to the representation depicted in FIG. 1H. The control device 130a can be configured to display the enlarged representation 702 in response to receiving an input selection of the representation 702 depicted in FIG. 7A.

In any case, the control device 130a can be configured to receive a selection of one of the transport controls and responsively control media playback by one of the on-LAN or off-LAN playback devices. For example, if the control device 130a receives a selection of one of the transport controls 706a in representation 704a, then the control device 130a can send an instruction for controlling playback of the on-LAN playback device 604 named “Living Room.” The control device 130a can determine that the Living Room device is an on-LAN device, and, based on that determination, the control device 130a can send the instruction to the on-LAN playback device over the local network 160 using the 802.11 based protocol.

Similarly, if the control device 130a receives a selection of one of the transport controls 708 in representation 702, then the control device 130a can send an instruction for controlling playback of the off-LAN playback device 602 named “Roam.” However, because the Roam device is an off-LAN device, the control device 130a cannot send the instruction to the Roam device over the local network 160 using the 802.11 based protocol. Instead, in some examples, the control device 130a can determine that the Roam device is an off-LAN device and, based on that determination, use the BLE protocol to send control data to the off-LAN playback device 602 for controlling media playback by the off-LAN playback device 602. For instance, the control device 130a can send an advertising packet to the off-LAN playback device 602 for establishing a BLE connection. After establishing the BLE connection, the control device 130a can send the control data to the off-LAN playback device 602 over the BLE connection. Once the control data is sent, the control device 130a can terminate the BLE connection. Additionally or alternatively, in examples where the control device 130a is streaming media content to the off-LAN playback device 602 using an existing BLUETOOTH connection, the control device 130a can send the control data to the off-LAN playback device 602 over the existing BLUETOOTH connection.

In some examples, the control device 130a can determine whether the off-LAN playback device 602 is a guest device. A guest device can be a device that is associated with a different household than the other devices in the MPS 600. For instance, an off-LAN device can be a portable device that a user brings with them to another user's household. In such a scenario, the off-LAN playback device 602 would be a guest device in the household. In this regard, each user can have a media playback system user account (e.g., a Sonos account) with an associated household identifier. When a user performs an initial setup of a playback device, the device can be associated with the user's household identifier. For instance, a cloud server can store a serial number of the device in association with the user's household identifier. As such, when the control device 130a receives information identifying an off-LAN playback device, the control device 130a can query the cloud server to determine whether the off-LAN playback device's serial number is associated with the same household identifier as the on-LAN playback devices. If the serial number is associated with the household identifier, then the control device 130a can determine that the off-LAN playback device 602 is not a guest device. However, if the serial number is not associated with the household identifier, then the control device 130a can determine that the off-LAN playback device 602 is a guest device.

Although referred to as a “household” identifier herein, it should be understood that a user's media playback system account might be associated with playback devices that are located in more than a single household. For example, a user may own playback devices that are located in their primary residence, at their office, at a vacation home, etc., all of which may be associated with the user's household identifier.

When the control device 130a determines that the off-LAN playback device 602 is a guest device, the control device 130a can treat the off-LAN playback device 602 differently, such as by modifying the manner in which the control device 130a displays the representation 702 of the off-LAN playback device 602 or by applying restrictions to the way a user can interact with the representation 702 of the off-LAN playback device 602. For instance, the control device 130a can include information in the representation 702 that labels the off-LAN playback device 602 as a guest device. As another example, the control device 130a can restrict a user's ability to control media playback at the off-LAN playback device 602, such as by removing some or all of the transport controls 708 from the representation 702 of the off-LAN playback device 602. Other examples are possible as well.

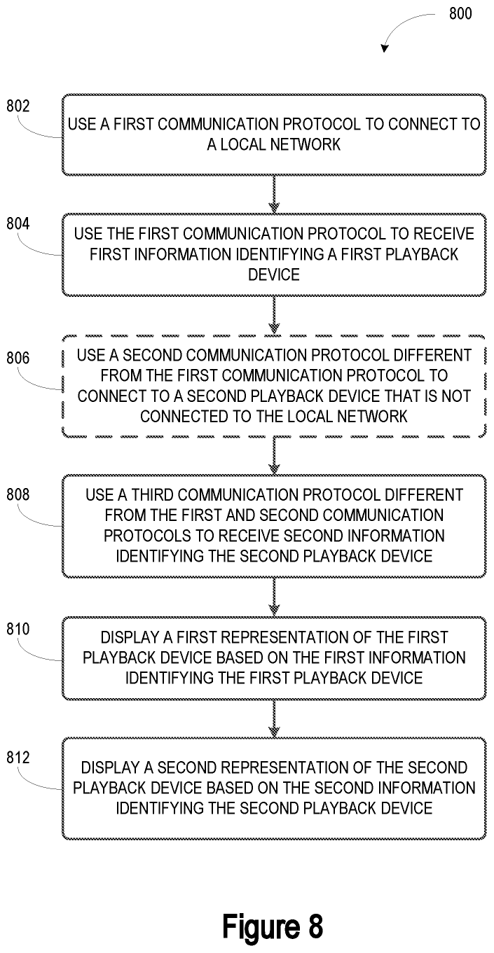

FIG. 8 is a flowchart 800 that illustrates an example implementation for displaying representations of on-LAN and off-LAN playback devices in a graphical interface of a control device. The on-LAN playback devices may be, for example, any of the on-LAN playback devices 604 described herein; the off-LAN playback devices may be, for example, any of the off-LAN playback devices 602 described herein; and the control device may be, for example, any of the control devices 130 described herein.

Beginning at block 802, the control device uses a first communication protocol to connect to a local network. The local network may be, for example, the local network 160 described herein, and the first communication protocol may be, for example, the 802.11 based protocol.

At block 804, the control device uses the first communication protocol to receive first information identifying a first playback device, where the first playback device is an on-LAN playback device connected to the local network. As such, the control device may use the 802.11 based protocol to receive the first information identifying the first playback device. The first identifying information can include any of the identifying information described herein, including information that identifies the first playback device itself and/or information identifying an operating state of the first playback device.

At block 806, the control device uses a second communication protocol that is different from the first communication protocol to connect to a second playback device, where the second playback device is an off-LAN playback device that is not connected to a local network in common with the control device (and/or not connected to any local network). The second protocol may be, for example, the BLUETOOTH protocol, and, after connecting to the second playback device, the control device can use the BLUETOOTH protocol to stream media content to the second playback device for playback by the second playback device.

Block 806 is shown in dashed lines because, in some examples, instead of the control device using the second communication protocol to connect to the second playback device, a different control device can use the second communication protocol to connect to the second playback device. An example of this arrangement is described above in connection with FIG. 6 in which the other control device 606 is streaming media content to the off-LAN playback device 602 via the BLUETOOTH connection 610.

At block 808, the control device uses a third communication protocol that is different from the first and second communication protocols to receive second information identifying the second playback device. The third protocol may be, for example, the BLE protocol and, similar to the first information identifying the first playback device, the second information identifying the second playback device can include any of the identifying information described herein, including information that identifies the second playback device itself and/or information identifying an operating state of the second playback device.

In some examples, the control device uses information obtained via the second communication protocol in order to obtain the second information using the third protocol. For instance, as described above, when the control device has established a BLUETOOTH connection with an off-LAN playback device, the control device can already have certain identifying information, such as the last four digits of the device's serial number. As such, the control device can search for a BLE beacon from a device that has the same last four digits of the serial number and extract the identifying information from the BLE beacon.

At block 810, the control device displays a first representation of the first playback device based on the first information identifying the first playback device. And at block 812, the control device displays a second representation of the second playback device based on the second information identifying the second playback device. As described above in connection with FIG. 7, the control device can display the first and second representations concurrently in a single interface so that an end-user can visualize both their on-LAN and off-LAN playback devices in the same interface.

In some examples, the control device can be configured to include transport controls in the first and second representations for controlling playback of media content by the first and second playback devices. The first representation of the first playback device can include a first set of transport controls for controlling playback of audio content by the first playback device, and the second representation of the second playback device can include a second set of transport controls for controlling playback of audio content by the second playback device. In these examples, the control device can be configured to receive, via its graphical interface, a selection of one of the first set of transport controls. In response to receiving the selection, the control device can use the first communication protocol to send, via the at least one communication interface, an instruction for controlling playback of audio content by the first playback device. Similarly, the control device can be configured to receive, via its graphical interface, a selection one of the second set of transport controls. In response to receiving the selection, the control device can use the second communication protocol or the third communication protocol to send, via the at least one communication interface, an instruction for controlling playback of audio content by the second playback device. For instance, the control device can send the instruction to the second playback device using the BLE protocol. Or if the control device is already connected to the second playback device over a BLUETOOTH connection for streaming media content, then the control device can send the instruction over the BLUETOOTH connection.

FIG. 8 includes one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowchart shown in FIG. 8 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block in FIGS. 5-8 may represent circuitry and/or machinery that is wired or arranged to perform the specific functions in the process.

### IV. CONCLUSION

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Example Features

(Feature 1) A computing device comprising: at least one processor; at least one communication interface; a display configured to present a graphical interface; a non-transitory computer-readable medium; and program instructions stored on the non-transitory computer-readable medium that are executable by the at least one processor such that the computing device is configured to: use a first communication protocol to connect, via the at least one communication interface, to a local network; use the first communication protocol to receive, via the at least one communication interface, first information identifying a first playback device connected to the local network; use a second communication protocol different from the first communication protocol to connect, via the at least one communication interface, to a second playback device that is not connected to the local network; use a third communication protocol different from the first and second communication protocols to receive, via the at least one communication interface, second information identifying the second playback device; and display, via the graphical interface, a first representation of the first playback device and a second representation of the second playback device, wherein the first representation is based on the first information identifying the first playback device and the second representation is based on the second information identifying the second playback device.

(Feature 2) The computing device of feature 1, wherein the program instructions that are executable by the at least one processor such that the computing device is configured to display the first representation of the first playback device and the second representation of the second playback device comprise program instructions that are executable by the at least one processor such that the computing device is configured to concurrently display the first representation of the first playback device and the second representation of the second playback device.

(Feature 3) The computing device of feature 1 or 2, wherein the program instructions that are executable by the at least one processor such that the computing device is configured to use the third communication protocol to receive the second information identifying the second playback device comprise program instructions that are executable by the at least one processor such that the computing device is configured to use the third communication protocol to receive the second information identifying the second playback device using information obtained via the second communication protocol.

(Feature 4) The computing device of any of features 1-3, wherein the first representation of the first playback device includes a first set of transport controls for controlling playback of audio content by the first playback device, and wherein the second representation of the second playback device includes a second set of transport controls for controlling playback of audio content by the second playback device.

(Feature 5) The computing device of feature 4, further comprising program instructions stored on the non-transitory computer-readable medium that are executable by the at least one processor such that the computing device is configured to: receive, via the graphical interface, a selection of one of the first set of transport controls; and after receipt of the selection, use the first communication protocol to send, via the at least one communication interface, an instruction for controlling playback of audio content by the first playback device.

(Feature 6) The computing device of feature 4, further comprising program instructions stored on the non-transitory computer-readable medium that are executable by the at least one processor such that the computing device is configured to: receive, via the graphical interface, a selection of one of the second set of transport controls; and after receipt of the selection, use the second communication protocol or the third communication protocol to send, via the at least one communication interface, an instruction for controlling playback of audio content by the second playback device.

(Feature 7) The computing device of any of features 1-6, further comprising program instructions stored on the non-transitory computer-readable medium that are executable by the at least one processor such that the computing device is configured to: use the second communication protocol to transmit, via the at least one communication interface, audio content to the second playback device for playback by the second playback device.

(Feature 8) The computing device of any of features 1-7, wherein the program instructions that are executable by the at least one processor such that the computing device is configured to use the third communication protocol to receive the second information identifying the second playback device comprise program instructions that are executable by the at least one processor such that the computing device is configured to receive a beacon transmitted by the second playback device, the beacon comprising the second information identifying the second playback device.

(Feature 9) The computing device of any of features 1-8, wherein the first communication protocol is a Wi-Fi protocol, wherein the second communication protocol is a Bluetooth classic protocol, and wherein the third communication protocol is a Bluetooth low energy (BLE) protocol.

(Feature 10) A non-transitory computer-readable medium, wherein the non-transitory computer-readable medium is provisioned with program instructions that, when executed by at least one processor, cause a computing device to: use a first communication protocol to connect, via at least one communication interface of the computing device, to a local network; use the first communication protocol to receive, via the at least one communication interface, first information identifying a first playback device connected to the local network; use a second communication protocol different from the first communication protocol to connect, via the at least one communication interface, to a second playback device that is not connected to the local network; use a third communication protocol different from the first and second communication protocols to receive, via the at least one communication interface, second information identifying the second playback device; and display, via a graphical interface of the computing device, a first representation of the first playback device and a second representation of the second playback device, wherein the first representation is based on the first information identifying the first playback device and the second representation is based on the second information identifying the second playback device.

(Feature 11) The non-transitory computer-readable medium of feature 10, wherein the program instructions that, when executed by at least one processor, cause the computing device to display the first representation of the first playback device and the second representation of the second playback device comprise program instructions that, when executed by at least one processor, cause the computing device to concurrently display the first representation of the first playback device and the second representation of the second playback device.

(Feature 12) The non-transitory computer-readable medium of feature 10 or 11, wherein the program instructions that, when executed by at least one processor, cause the computing device to use the third communication protocol to receive the second information identifying the second playback device comprise program instructions that, when executed by at least one processor, cause the computing device to use the third communication protocol to receive the second information identifying the second playback device using information obtained via the second communication protocol.

(Feature 13) The non-transitory computer-readable medium of any of features 10-12, wherein the first representation of the first playback device includes a first set of transport controls for controlling playback of audio content by the first playback device, and wherein the second representation of the second playback device includes a second set of transport controls for controlling playback of audio content by the second playback device.

(Feature 14) The non-transitory computer-readable medium of feature 13, wherein the non-transitory computer-readable medium is also provisioned with program instructions that, when executed by at least one processor, cause the computing device to: receive, via the graphical interface, a selection of one of the second set of transport controls; and after receipt of the selection, use the second communication protocol or the third communication protocol to send, via the at least one communication interface, an instruction for controlling playback of audio content by the second playback device.

(Feature 15) The non-transitory computer-readable medium of any of features 10-14, wherein the non-transitory computer-readable medium is also provisioned with program instructions that, when executed by at least one processor, cause the computing device to: use the second communication protocol to transmit, via the at least one communication interface, audio content to the second playback device for playback by the second playback device.

(Feature 16) A method carried out by a computing device, the method comprising: using a first communication protocol to connect, via at least one communication interface of the computing device, to a local network; using the first communication protocol to receive, via the at least one communication interface, first information identifying a first playback device connected to the local network; using a second communication protocol different from the first communication protocol to connect, via the at least one communication interface, to a second playback device that is not connected to the local network; using a third communication protocol different from the first and second communication protocols to receive, via the at least one communication interface, second information identifying the second playback device; and displaying, via a graphical interface of the computing device, a first representation of the first playback device and a second representation of the second playback device, wherein the first representation is based on the first information identifying the first playback device and the second representation is based on the second information identifying the second playback device.

(Feature 17) The method of feature 16, wherein displaying the first representation of the first playback device and the second representation of the second playback device comprises concurrently displaying the first representation of the first playback device and the second representation of the second playback device.

(Feature 18) The method of feature 16 or 17, wherein using the third communication protocol to receive the second information identifying the second playback device comprises using the third communication protocol to receive the second information identifying the second playback device using information obtained via the second communication protocol.

(Feature 19) The method of any of features 16-18, wherein the first representation of the first playback device includes a first set of transport controls for controlling playback of audio content by the first playback device, wherein the second representation of the second playback device includes a second set of transport controls for controlling playback of audio content by the second playback device, and wherein the method further comprises: receiving, via the graphical interface, a selection of one of the second set of transport controls; and after receipt of the selection, using the second communication protocol or the third communication protocol to send, via the at least one communication interface, an instruction for controlling playback of audio content by the second playback device.

(Feature 20) The method of any of features 16-19, further comprising: using the second communication protocol to transmit, via the at least one communication interface, audio content to the second playback device for playback by the second playback device.

1-15. (canceled)

16. A computing device comprising:
at least one processor;
at least one communication interface;
a display configured to present a graphical interface;
a non-transitory computer-readable medium; and
program instructions stored on the non-transitory computer-readable medium that are executable by the at least one processor such that the computing device is configured to:
use a first communication protocol to connect, via the at least one communication interface, to a local network;
use the first communication protocol to receive, via the at least one communication interface, first information identifying a first playback device connected to the local network;
use a second communication protocol different from the first communication protocol to connect, via the at least one communication interface, to a second playback device that is not connected to the local network;
use a third communication protocol different from the first and second communication protocols to receive, via the at least one communication interface, second information identifying the second playback device; and
display, via the graphical interface, a first representation of the first playback device and a second representation of the second playback device, wherein the first representation is based on the first information identifying the first playback device and the second representation is based on the second information identifying the second playback device.

17. The computing device of claim 16, wherein the program instructions that are executable by the at least one processor such that the computing device is configured to display the first representation of the first playback device and the second representation of the second playback device comprise program instructions that are executable by the at least one processor such that the computing device is configured to concurrently display the first representation of the first playback device and the second representation of the second playback device.

18. The computing device of claim 16, wherein the program instructions that are executable by the at least one processor such that the computing device is configured to use the third communication protocol to receive the second information identifying the second playback device comprise program instructions that are executable by the at least one processor such that the computing device is configured to use the third communication protocol to receive the second information identifying the second playback device using information obtained via the second communication protocol.

19. The computing device of claim 16, wherein the first representation of the first playback device includes a first set of transport controls for controlling playback of audio content by the first playback device, and wherein the second representation of the second playback device includes a second set of transport controls for controlling playback of audio content by the second playback device.

20. The computing device of claim 19, further comprising program instructions stored on the non-transitory computer-readable medium that are executable by the at least one processor such that the computing device is configured to:
receive, via the graphical interface, a selection of one of the first set of transport controls; and
after receipt of the selection, use the first communication protocol to send, via the at least one communication interface, an instruction for controlling playback of audio content by the first playback device.

21. The computing device of claim 19, further comprising program instructions stored on the non-transitory computer-readable medium that are executable by the at least one processor such that the computing device is configured to:
receive, via the graphical interface, a selection of one of the second set of transport controls; and
after receipt of the selection, use the second communication protocol or the third communication protocol to send, via the at least one communication interface, an instruction for controlling playback of audio content by the second playback device.

22. The computing device of claim 16, further comprising program instructions stored on the non-transitory computer-readable medium that are executable by the at least one processor such that the computing device is configured to:
use the second communication protocol to transmit, via the at least one communication interface, audio content to the second playback device for playback by the second playback device.

23. The computing device of claim 16, wherein the program instructions that are executable by the at least one processor such that the computing device is configured to use the third communication protocol to receive the second information identifying the second playback device comprise program instructions that are executable by the at least one processor such that the computing device is configured to receive a beacon transmitted by the second playback device, the beacon comprising the second information identifying the second playback device.

24. The computing device of claim 16, wherein the first communication protocol is a Wi-Fi protocol, wherein the second communication protocol is a Bluetooth classic protocol, and wherein the third communication protocol is a Bluetooth low energy (BLE) protocol.

25. A non-transitory computer-readable medium, wherein the non-transitory computer-readable medium is provisioned with program instructions that, when executed by at least one processor, cause a computing device to:
use a first communication protocol to connect, via at least one communication interface of the computing device, to a local network;
use the first communication protocol to receive, via the at least one communication interface, first information identifying a first playback device connected to the local network;
use a second communication protocol different from the first communication protocol to connect, via the at least one communication interface, to a second playback device that is not connected to the local network;
use a third communication protocol different from the first and second communication protocols to receive, via the at least one communication interface, second information identifying the second playback device; and
display, via a graphical interface of the computing device, a first representation of the first playback device and a second representation of the second playback device, wherein the first representation is based on the first information identifying the first playback device and the second representation is based on the second information identifying the second playback device.

26. The non-transitory computer-readable medium of claim 25, wherein the program instructions that, when executed by at least one processor, cause the computing device to display the first representation of the first playback device and the second representation of the second playback device comprise program instructions that, when executed by at least one processor, cause the computing device to concurrently display the first representation of the first playback device and the second representation of the second playback device.

27. The non-transitory computer-readable medium of claim 25, wherein the program instructions that, when executed by at least one processor, cause the computing device to use the third communication protocol to receive the second information identifying the second playback device comprise program instructions that, when executed by at least one processor, cause the computing device to use the third communication protocol to receive the second information identifying the second playback device using information obtained via the second communication protocol.

28. The non-transitory computer-readable medium of claim 25, wherein the first representation of the first playback device includes a first set of transport controls for controlling playback of audio content by the first playback device, and wherein the second representation of the second playback device includes a second set of transport controls for controlling playback of audio content by the second playback device.

29. The non-transitory computer-readable medium of claim 28, wherein the non-transitory computer-readable medium is also provisioned with program instructions that, when executed by at least one processor, cause the computing device to:
receive, via the graphical interface, a selection of one of the second set of transport controls; and
after receipt of the selection, use the second communication protocol or the third communication protocol to send, via the at least one communication interface, an instruction for controlling playback of audio content by the second playback device.

30. The non-transitory computer-readable medium of claim 25, wherein the non-transitory computer-readable medium is also provisioned with program instructions that, when executed by at least one processor, cause the computing device to:
use the second communication protocol to transmit, via the at least one communication interface, audio content to the second playback device for playback by the second playback device.

31. A method carried out by a computing device, the method comprising:
using a first communication protocol to connect, via at least one communication interface of the computing device, to a local network;
using the first communication protocol to receive, via the at least one communication interface, first information identifying a first playback device connected to the local network;
using a second communication protocol different from the first communication protocol to connect, via the at least one communication interface, to a second playback device that is not connected to the local network;
using a third communication protocol different from the first and second communication protocols to receive, via the at least one communication interface, second information identifying the second playback device; and
displaying, via a graphical interface of the computing device, a first representation of the first playback device and a second representation of the second playback device, wherein the first representation is based on the first information identifying the first playback device and the second representation is based on the second information identifying the second playback device.

32. The method of claim 31, wherein displaying the first representation of the first playback device and the second representation of the second playback device comprises concurrently displaying the first representation of the first playback device and the second representation of the second playback device.

33. The method of claim 31, wherein using the third communication protocol to receive the second information identifying the second playback device comprises using the third communication protocol to receive the second information identifying the second playback device using information obtained via the second communication protocol.

34. The method of claim 31, wherein the first representation of the first playback device includes a first set of transport controls for controlling playback of audio content by the first playback device, wherein the second representation of the second playback device includes a second set of transport controls for controlling playback of audio content by the second playback device, and wherein the method further comprises:
receiving, via the graphical interface, a selection of one of the second set of transport controls; and
after receipt of the selection, using the second communication protocol or the third communication protocol to send, via the at least one communication interface, an instruction for controlling playback of audio content by the second playback device.

35. The method of claim 31, further comprising:
using the second communication protocol to transmit, via the at least one communication interface, audio content to the second playback device for playback by the second playback device.
